(19) United States
(12) Patent Application Publication
(10) Pub. No.: US 2016/0373311 A1
(43) Pub. Date: Dec. 22, 2016

(54) SYSTEM FOR END-USER MANAGEMENT OF A BANDWIDTH OF TELECOMMUNICATIONS SERVICES

(71) Applicant: Transition Networks, Inc., Minnetonka, MN (US)

(72) Inventors: Anita Kumar, Edina, MN (US); James C. Maki, St. Francis, MN (US)

(21) Appl. No.: 15/182,884

(22) Filed: Jun. 15, 2016

Related U.S. Application Data
(60) Provisional application No. 62/180,305, filed on Jun. 16, 2015.

(51) Int. Cl. H04L 12/24; G06T 11/20; G06F 3/0484; G06F 3/0482

(52) U.S. Cl. CPC H04L 41/22; H04L 41/0896; G06F 3/0482; G06T 11/206; G06F 3/0484

(57) ABSTRACT

Disclosed embodiments include applications, computing devices configured with the applications, and computer implemented methods to provide user interfaces on the mobile computing devices to allow customers to manage and change bandwidth allocation for their services without taking down the telecommunications services.

This application claims the benefit of U.S. Provisional Application No. 62/180,305, filed Jun. 16, 2015, and titled “MOBILE COMPUTING DEVICE AND APP CONFIGURING SAME TO ALLOW END CUSTOMERS TO CHANGE BANDWIDTH ON DEMAND FOR THEIR SERVICES”.

### BACKGROUND OF THE INVENTION

The present invention relates to managing bandwidth of services provided by a service provider to a customer.

Internet or other network based services, such as voice (e.g., voice over IP or VoIP), video and data services are typically purchased from a service provider based at least in part on desired or needed bandwidth. Networks providing and using such services have been statically configured for years. If end customers want to get additional bandwidth on a service that they have purchased from a service provider, they have to call the service provider to request a change of service. The service provider then creates a work order to process the change. This change may take days or weeks and sometimes requires the service to be taken down to process the change and thus it has to be done in a maintenance window. This prevents end customers from being able to have flexibility to change their bandwidth as needed only for the time the change is needed

The discussion above is merely provided for general background information and is not intended to be used as an aid in determining the scope of the claimed subject matter.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Disclosed embodiments include applications, computing devices configured with the applications, and computer implemented methods to provide user interfaces on the mobile computing devices to allow customers to manage and change, on demand, bandwidth allocation for their services. Disclosed embodiments enable the end customer to be able to dynamically allocate bandwidth between services the customer had purchased or add more bandwidth if needed. The application and corresponding graphical user interface (GUI) shows a graphical view of the services available, shows the bandwidth allocated to each service, and provides mechanisms for the end customer or user to dynamically change the bandwidth allocated to various services.

For example, exemplary embodiments include a method for end-user management of bandwidth of telecommunications services. The method may include providing, by an end-user application running on an end-user device, a GUI on a screen of the end-user device. The method may also include receiving, via an input field of the GUI, an input indicative of a selected bandwidth of one of the telecommunications services. The method may also include communicating the selected bandwidth to a management server. In such embodiments, the management server can be configured to change bandwidth allocation of the telecommunications services according to the selected bandwidth. The method may also include receiving, by the end-user device, the one of the telecommunications services corresponding to the selected bandwidth according to the changed bandwidth allocation.

In some embodiments, the method may further include displaying, in the GUI, services of the telecommunications services available to the end-user device. The method may also include displaying respective bandwidths of the services available to the end-user device. In such an example, the method may further include displaying, in a first portion of the GUI, a bar of a bar graph that is indicative of one of the respective bandwidths. In such examples, the vertical height of the bar is representative of the size of the bandwidth, and the horizontal width of the bar is representative of the amount of the bandwidth that is being utilized. Also, in such embodiments, the method may further include displaying, in a second portion of the GUI, a pie chart that is indicative of the size of the bandwidth, and displaying a wedge in the pie chart that is representative of the amount of the bandwidth that is being utilized.

In some embodiments, the method may further include displaying, in the GUI, a respective status of incoming traffic of one of the telecommunications services, which includes whether the incoming traffic is passed through or whether some traffic is dropped. In such an example, the method may further include: comparing, by the end-user application, the incoming traffic with an allocated bandwidth and an excess information rate of the telecommunications service, and determining a visual indication of the respective status of the incoming traffic of the telecommunications service based on the comparison. Also, in such embodiments, the method may further include displaying, in the GUI, the service as passed through, if the incoming traffic is less than the allocated bandwidth. Also, it may include displaying, in the GUI, the service as passed through on a best-effort delivery basis, if the incoming traffic is greater than the allocated bandwidth, but less than a summation of the allocated bandwidth and the excess information rate. It may also include displaying, in the GUI, the service as some traffic is dropped, if the incoming traffic is greater than the summation.

Also, for example, exemplary embodiments include a system for end-user management of bandwidth of telecommunications services. They system may include an end-user application configured to run on an end-user device and communicate with a management server that is configured to control bandwidth allocation of telecommunications services provided to the end-user device. Also, the application may be configured to communicate a selected bandwidth to the management server to change the bandwidth allocation of the telecommunications services. Such a system can also include a GUI provided by the application. The GUI may be configured to display on a screen of the end-user device, and provide an input field configured to receive input indicative of the selected bandwidth.

In some embodiments, the GUI of the system may be further configured to display services of the telecommunications services that are available to the end-user device, and display respective available bandwidths of the services that are available to the end-user device. In such embodiments, each of the displayed available bandwidths may include a bar of a bar graph, wherein the vertical height of the bar is representative of the size of the available bandwidth, and wherein the horizontal width of the bar is representative of the amount of the available bandwidth that is being utilized. Additionally, or alternatively, each of the displayed available bandwidths may include a pie chart, wherein a wedge of the pie chart is representative of the amount of the available bandwidth that is being utilized.

In some embodiments, the GUI of the system may be further configured to display a respective status of incoming traffic of one of the telecommunications services, which includes whether the incoming traffic is passed through or whether some traffic is dropped. Also, in such embodiments, the displayed status of the incoming traffic may be based on a comparison of the incoming traffic with an allocated bandwidth and an excess information rate of the corresponding service. For example, if the incoming traffic is less than the allocated bandwidth, the service is shown as passed through. If the incoming traffic is greater than the allocated bandwidth, but less than the summation of the allocated bandwidth and the excess information rate, the service is shown as passed on a best-effort delivery basis. Finally, if the incoming traffic is greater than the summation, the service is shown as some traffic is dropped.

In some embodiments, the GUI of the system may be further configured to display changes to the bandwidth allocation of the telecommunications services in real time. Also, in some embodiments, the end-user application may be configured to communicate the selected bandwidth to the management server through an application program interface (API).

Also, for example, exemplary embodiments include yet another system for end-user management of bandwidth of telecommunications services. This other system may include communication circuitry and control circuitry of a management server. The communication circuitry may be configured to communicate with an end-user application running on an end-user device. In such an embodiment, the end-user application may include a GUI configured to display on a screen of the end-user device. The communication circuitry may also be configured to receive input indicative of a selected bandwidth of one of the telecommunications services via an input field of the GUI, wherein the one telecommunications service is provided to the end-user device.

The control circuitry of the management server may be configured to control bandwidth allocation of the telecommunications services to the end-user device, and change the bandwidth allocation according to the selected bandwidth. In some embodiments, the selected bandwidth can be selected from a list of available bandwidths of the telecommunications services displayed on the GUI. Each of the displayed bandwidths may include a bar of a bar graph, wherein the vertical height of the bar is representative of the size of the available bandwidth, and wherein the horizontal width of the bar is representative of the amount of the available bandwidth that is being utilized. In some embodiments, the control circuitry can be configured to change the bandwidth allocation of the telecommunications services almost instantaneously without taking down the telecommunications services. In some embodiments, the control circuitry can be configured to control the bandwidth allocation by configuring network devices of the telecommunications services. In such embodiments, the network devices include flash memory configured to store changes to the bandwidth allocation of the telecommunications services.

### BRIEF DESCRIPTION OF THE DRAWINGS

FIG. 1 is a block diagram illustrating an example embodiment of a computing device configured in accordance with exemplary embodiments.

FIG. 2 is a block diagram of a system which allows end customers to manage and change bandwidth allocation for services from a service provider.

FIGS. 3-12 are diagrammatic illustrations of GUI screens generated by an application running on the computing device of FIG. 1 to manage, configure or change bandwidth allocation for services.

FIG. 13 is a flow chart illustrating an example embodiment of operations of the system of FIG. 2 in accordance with exemplary embodiments.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “connected,” “coupled” and variations thereof are used broadly and encompass both direct and indirect connections and couplings. Further, “connected” and “coupled” are not restricted to physical or mechanical connections or couplings.

Exemplary embodiments of the disclosed invention preferably include, and operate to configure, a computer such as a tablet computer, a mobile computing device such as a smart phone, a laptop computer, a desktop computer, or other computing devices, particularly computing devices having a touch screen input GUI. The exemplary embodiments include computer implemented methods, computer readable instructions, and configured computing devices which facilitate communication with a management system to configure network interface devices (NIDs) to provide dynamic bandwidth control for services, such as voice, video and data services, provided by a service provider.

Although not required, disclosed embodiments are described in the general context of computer-executable instructions, such as program modules or applications, being executed by an electronic device such as a tablet computer or other computing device. Generally, program modules include routines, programs, objects, components, data structures, etc. that configure a processor or other computing device perform particular tasks. In embodiments, the disclosed embodiments may be practiced in distributed computing environments where tasks are performed by remote processing devices that are linked through a communications network. In a distributed computing environment, program modules may be located in both local and remote memory storage devices.

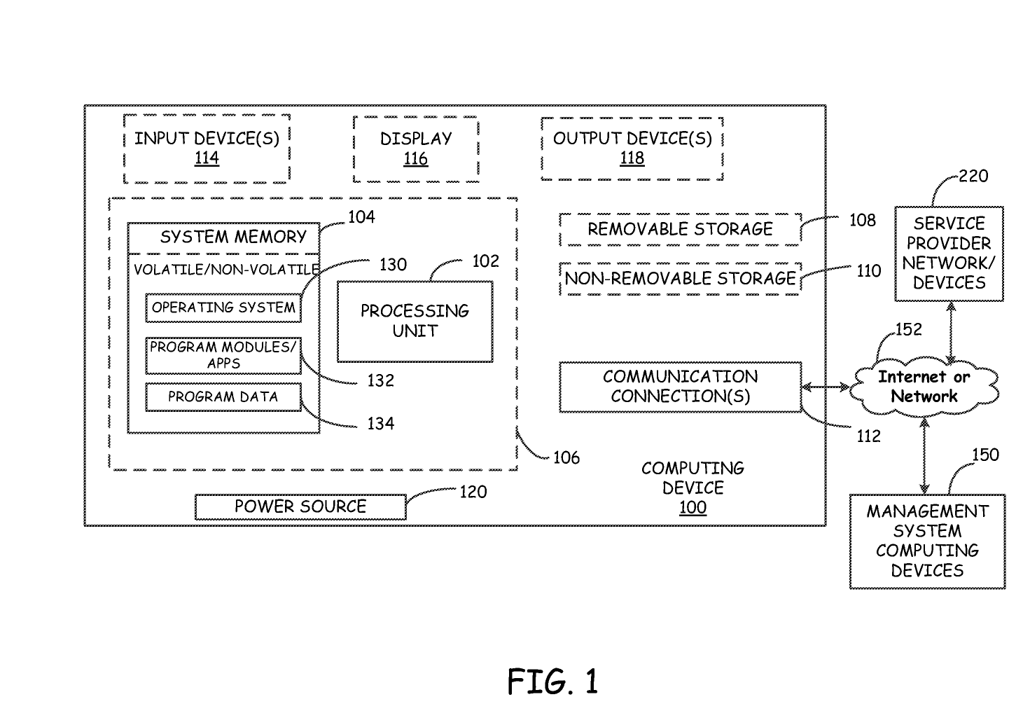

FIG. 1 shows an exemplary end-user computing device 100 for implementing exemplary disclosed embodiments. While in exemplary embodiments of end-user device 100 is a tablet type of computer or a mobile phone such as a smart phone, device 100 can be other types of computers and is therefore described in the context of a general computing device. In its most basic configuration, the end-user device 100 includes at least a processing unit 102 and a memory 104. Depending on the exact configuration and type of computing device, the memory 104 may be volatile (such as RAM), non-volatile (such as ROM, flash memory, etc.) or some combination of the two. This most basic configuration is illustrated in FIG. 1 by a dashed line 106.

Additionally, the device 100 may also have additional features/functionality. For example, the device 100 may also include additional storage (removable and/or non-removable) including, but not limited to, magnetic or optical disks or tapes, USB flash drives, memory cards, etc. Such additional storage is illustrated in FIG. 1 by a removable storage 108 and a non-removable storage 110. Computer storage media includes volatile and nonvolatile, removable and non-removable media implemented in any method or technology for storage of information such as computer readable instructions, data structures, program modules or other data. The memory 104, the removable storage 108 and the non-removable storage 110 are all examples of computer storage media. Computer storage media includes, but is not limited to, RAM, ROM, EEPROM, flash memory or other memory technology, CDROM, digital versatile disks (DVD) or other optical storage, magnetic cassettes, magnetic tape, magnetic disk storage or other magnetic storage devices, or any other medium which can be used to store the desired information and which can be accessed by the device 100. Any such computer storage media may be part of the device 100.

In the description that follows, disclosed embodiments will be described with reference to acts and symbolic representations of operations that are performed by one or more devices, unless indicated otherwise. As such, it will be understood that such acts and operations, which are at times referred to as being computer-executed, include the manipulation by the processing unit of the device of electrical signals representing data in a structured form. This manipulation transforms the data or maintains it at locations in the memory system of the device, which reconfigures or otherwise alters the operation of the device in a manner well understood by those skilled in the art. The data structures where data is maintained are physical locations of the memory that have particular properties defined by the format of the data. However, while disclosed embodiments are described in the foregoing context, it is not meant to be limiting as those of skill in the art will appreciate that various of the acts and operations described hereinafter may also be implemented in hardware or firmware.

System memory 104 may include operating system 130, one or more programming modules or applications 132, and program data 134. Operating system 130, for example, may be suitable for controlling end-user device 100's operation. As stated above, a number of program modules 132 and data files 134 may be stored in system memory 104, including operating system 130. While executing on processing unit 102, programming modules or applications 132 may perform processes including, for example, one or more methods described herein, using one or more of the GUI screens or windows shown and described herein.

Generally, consistent with disclosed embodiments, program modules or applications may include routines, programs, components, data structures, and other types of structures that may perform particular tasks or that may implement particular abstract data types. Moreover, disclosed embodiments may be practiced with other computer system configurations, including multiprocessor systems, microprocessor-based or programmable consumer electronics, minicomputers, mainframe computers, and the like. Disclosed embodiments may also be practiced in distributed computing environments where tasks are performed by remote processing devices that are linked through a communications network. In a distributed computing environment, program modules may be located in both local and remote memory storage devices.

Furthermore, some disclosed embodiments may be practiced in an electrical circuit including discrete electronic elements, packaged or integrated electronic chips containing logic gates, a circuit utilizing a microprocessor, or on a single chip containing electronic elements or microprocessors. Some disclosed embodiments may also be practiced using other technologies capable of performing logical operations such as, for example, AND, OR, and NOT, including but not limited to mechanical, optical, fluidic, and quantum technologies. In addition, some disclosed embodiments may be practiced within a general purpose computer or in any other circuits or systems.

Disclosed embodiments, for example, may be implemented as a computer process (method), a computing system, or as an article of manufacture, such as a computer program product or computer readable media. The computer program product may be a computer storage media readable by a computer system and encoding a computer program of instructions for executing a computer process. Accordingly, the disclosed embodiments may be embodied in hardware and/or in software (including firmware, resident software, micro-code, etc.). In other words, some disclosed embodiments may take the form of a computer program product on a computer-usable or computer-readable storage medium having computer-usable or computer-readable program code embodied in the medium for use by or in connection with an instruction execution system. A computer-usable or computer-readable medium may be any non-transitory medium that can contain, store, communicate, propagate, or transport the program for use by or in connection with the instruction execution system, application, apparatus, or device.

The device 100 may also contain one or more communications connections 112 that allow the device to communicate with other devices. The communications connections 112 can include, for example, wired media connections such as a wired network or direct-wired connection, and wireless media connections such as acoustic, RF, infrared and other wireless media connections. In exemplary embodiments, communications connections 112 are configured to provide communication between end-user device 100 and a management system computing device 150, such as a management system server of the service provider, over a computer network 152 such as the Internet.

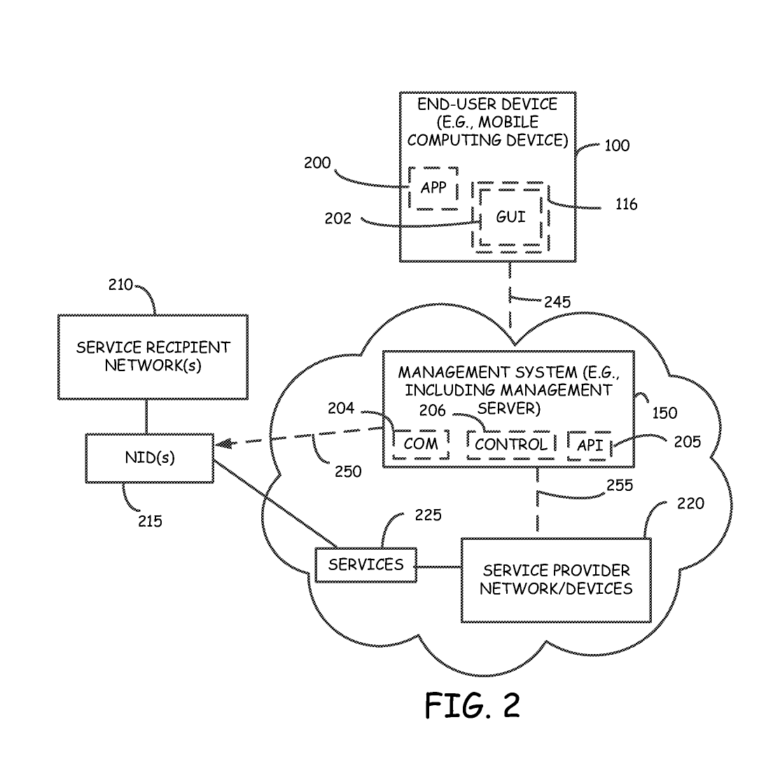

Referring to FIGS. 1 and 2, the communications connections 112 can also provide communication with service provider networks or devices 220 in some embodiments, for receiving services such as voice, video or data services. In exemplary embodiments, end-user device 100 is configured to provide GUI's which communicate with management system computing device 150 to manage, configure or change bandwidth of services from the service provider. The management device 150 may include one or more computers including a management server. Connection to the computer network can include wireless communication, cellular data communication, and/or any other type of connection.

In some exemplary embodiments, communications with the management system computing device 150 can be enabled by communication circuitry 204 of the device 150. The communication circuitry 204 can be configured to communicate with end-user application 200 running on the end-user device 100. The end-user application 200 can include GUI 202 that can be configured to display on a screen of the end-user device. The GUI 202 can also be configured to receive input indicative of a selected bandwidth of one of the telecommunications services 225 via an input field of the GUI.

In some exemplary embodiments in which device 100 is a tablet computer, instead of communication connections 112 connecting directly to Internet or network 152, communication connections 112 can include one or both of USB communication circuitry and wireless communication circuitry for communicating through network routers and other server computers which provide the connection to the Internet or other computer network 152.

In exemplary embodiments the end-user device 100 has, or can be coupled to, a touch screen display device 116 which provides a touch based GUI. The device 100 may also have, or be coupled to, one or more input devices 114, such as a keyboard, mouse, pen, voice input device, etc., for providing other input to the computing device. The device 100 may be coupled to one or more other output devices 118 such as speakers, a printer, a vibration generator, etc. Further, display device 116, input devices 114 and output devices 118 can all be considered to be separate from, or alternatively part of, end-user device 100.

End-user device 100 can be provided with a portable or non-portable power source 120, such as a battery pack, a transformer, a power supply, or the like. The power source 120 provides power for computations, communications and so forth by the device 100.

Referring to FIG. 2, shown is end-user device 100 having display device 116, for example a touch screen display device of a tablet computer, with the processing unit 102 of end-user device 100 configured with an exemplary end-user application 200 (of program modules/applications 132). End-user application 200 configures processing unit 102 to provide GUI's (e.g., GUI 202) to allow a purchaser or end customer of services from a service provider to configure network devices (NIDs) 215 and/or other systems or devices, using management system computing device 150 of the service provider, to control and manage bandwidth allocation for the services. End-user device 100 communicates with the device 150 using communications path or paths 245, which may include wireless based internet access, cellular data internet access, etc. The NIDs 215 may include one or more demarcation switch devices. The devices 215 may also provide access points for the customer's networks or devices 210 to services 225 provided by the service provider's networks or devices 220. For example, services 225 provided by the service provider's networks or devices can include voice (e.g., VoIP), video and data service, among others.

The end-user application 200 also communicates with management system computing device 150 via the management server's application program interface (API) 205 to configure the NIDs 215. Based on the values input into the end-user application 200 by the application user, the application determines the API calls to be made and the values to be configured on the NIDs 215. Device 150 can communicate with the NIDs 215 via communication connection 250. Once the configuration is complete, the application updates the GUI to show the new bandwidth configurations. The application shows a graphical view of the services available and shows the bandwidth allocated to each service. The changes made to the configuration are stored on the flash memory on at least one of the NIDs 215. The changes in configuration can be made almost instantaneously without taking down the service. This allows for the user to dynamically change the bandwidth on demand. In some embodiments, the management system computing device 150 also responsively communicates with the service provider networks or devices 220, via communications connection 255, to communicate with and/or configure the service provider's network or devices to provide the services with the new bandwidth allocations.

The management system computing device 150 can also include control circuitry 206 configured to control bandwidth allocation of the services 225 to the end-user device 100. The control circuitry 206 can also be configured to change the bandwidth allocation according to the selected bandwidth received through the GUI 202. The selected bandwidth may be selected from a list of available bandwidths of the telecommunications services displayed on the GUI 202. Each of the displayed bandwidths may include a bar of a bar graph. The vertical height of the bar may be representative of the size of the available bandwidth, and the horizontal width of the bar may be representative of the amount of the available bandwidth that is being utilized, or vice versa. The control circuitry 206 may also be configured to change the bandwidth allocation of the telecommunications services almost instantaneously without taking down the telecommunications services. The control circuitry may also be configured to control the bandwidth allocation by configuring the networks or devices 220 as well as the NIDs 215.

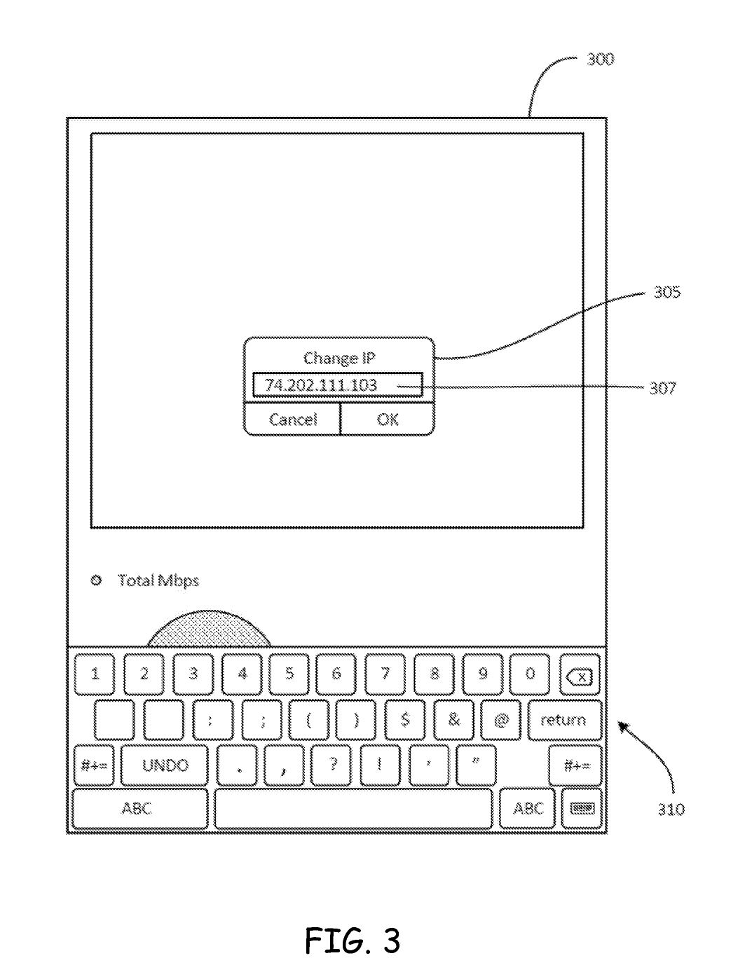

Referring to FIG. 3, shown is a Login screen 300 of the end-user application 200 which provides an input field 307 and dialog box 305, which allows the application user to login to the management system computing device 150 by entering the IP address of the service receiving end-user device (e.g., device 100). In some embodiments, a registered user device may login without inputting login information, such as by having a registered IP address that can be inputted in the background. For example, end-user device 100 may be a registered device. Also, a soft keyboard 310 can be displayed for the user to input login information in some other embodiments. Other login information, such as usernames and passwords, can also be inputted in other embodiments.

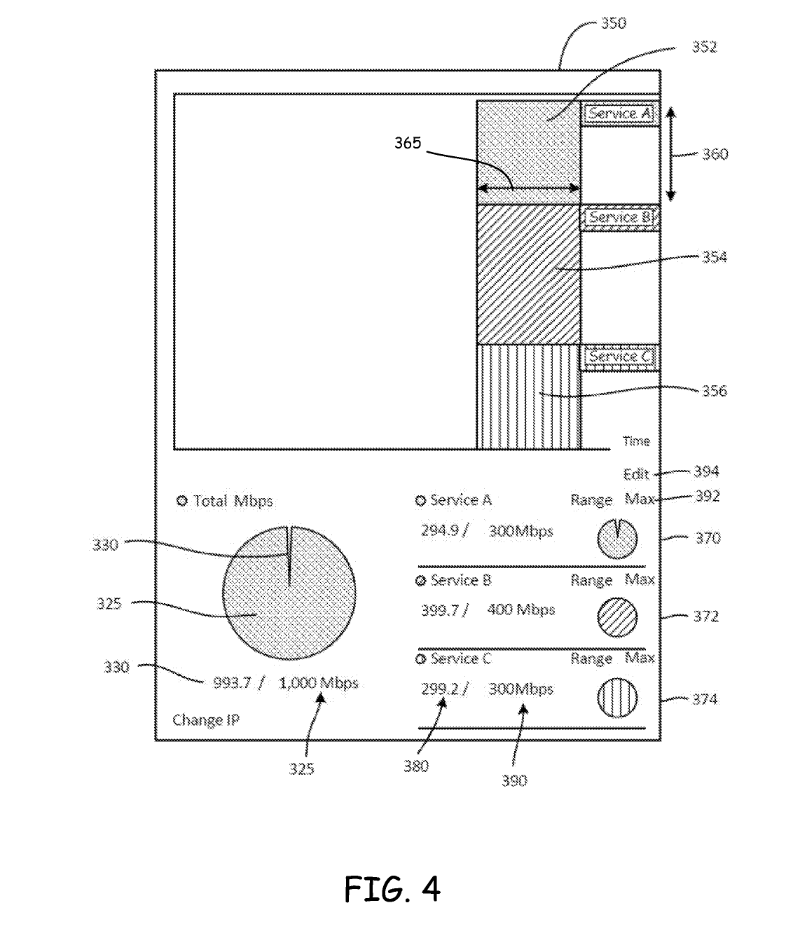

Referring to FIG. 4, shown is a screen 350 of the end-user application 200 GUI which illustrates the services that the end user has access to. In this example the services are A, B and C. In another example, the services could be voice, video, data. The top part of the screen shows a visual indication of the size of committed information rates (CIR) or bandwidths as it is generally referred to. The bandwidth for each service is represented by a corresponding “pipe” 352, 354 and 356, respectively. The vertical height 360 of a particular pipe, relative to the height of the other pipes, is graphically or visually representative of the size of the available bandwidth for the corresponding service. The horizontal width 365 of a particular pipe is graphically or visually representative of the amount of bandwidth which has been utilized. In this example, Service A has been allocated 300 Mbps, Service B 400 Mbps and Service C 300 Mbps. As noted, the size of the pipes 352, 354 and 356 visually indicate the size of the bandwidths. If the bandwidth is changed, the application adjusts the sizes of the pipes to visually show the change.

In exemplary embodiments, colors are used to indicate whether all the incoming traffic is passed through or whether some traffic is dropped. The application makes this calculation by comparing the incoming traffic with the allocated bandwidth (CIR) and the excess information rate (EIR). The EIR is set outside of the application. In this example, it has been set to be 10 Mbps. In some exemplary embodiments, if the incoming traffic is less than the CIR, the service is shown as green as all the incoming traffic is passed without any drops. If the incoming traffic is greater than the CIR, but less than the CIR+EIR, the service is shown as yellow as the incoming traffic is passed on a best effort basis. If the incoming traffic is greater than the CIR+EIR, the service is shown as red as not all the incoming traffic passes through and some of the traffic is dropped. As traffic continues to flow, the colored bars or pipes 352, 354 and 356 move towards the left and any changes are reflected in real time.

The bottom part of the screen is where the end user can dynamically change the bandwidth and see the change happen in real-time without having to take down the service or wait for days for a work order to be completed. The dynamic adjustment of bandwidth allows maximum flexibility and control to the end user. As shown in FIG. 4, a maximum total bandwidth 325 available for all services is illustrated numerically, as is the actual total bandwidth 330 currently being used. The maximum total bandwidth 325 and actual total bandwidth 330 currently being used are also illustrated in pie chart form to give a graphical representation to the user.

Also at the bottom of the screen, each of the services has a separate dynamic bandwidth changing area 370, 372 and 374, which illustrates the actual bandwidth used for the service (e.g., bandwidth used 380 for service C) and the maximum bandwidth commanded for the service (e.g., maximum commanded bandwidth 390 for service C). An input 392 allows the user to select a maximum bandwidth GUI view or a bandwidth range GUI view. An input 394 allows the user to edit the information.

In exemplary embodiments, the application allows two methods of changing the bandwidth:

Method 1: Change Maximum Bandwidth

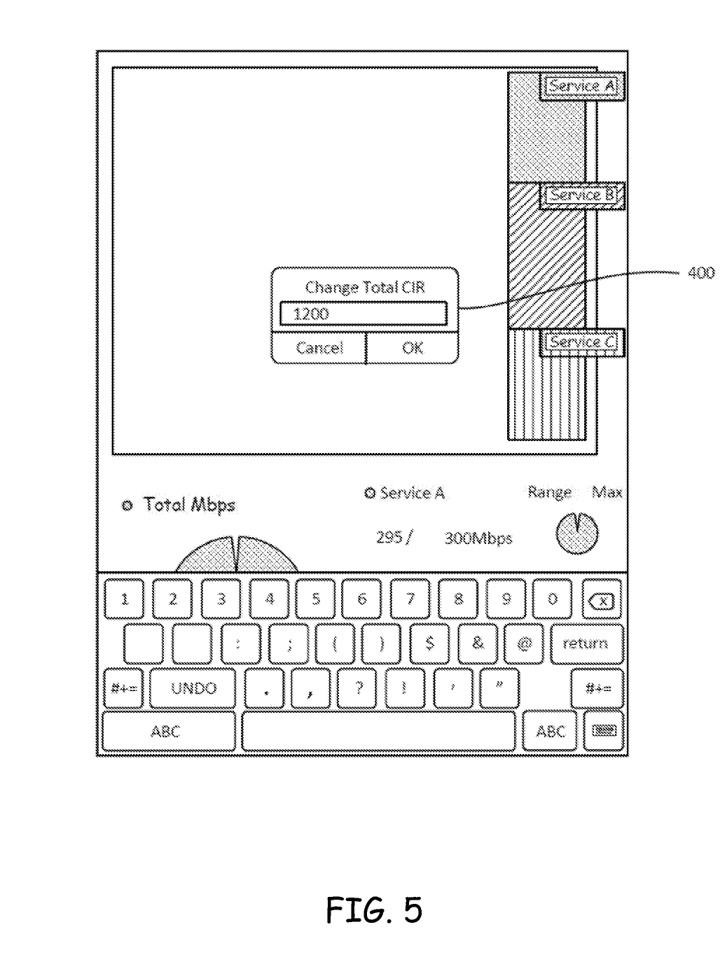

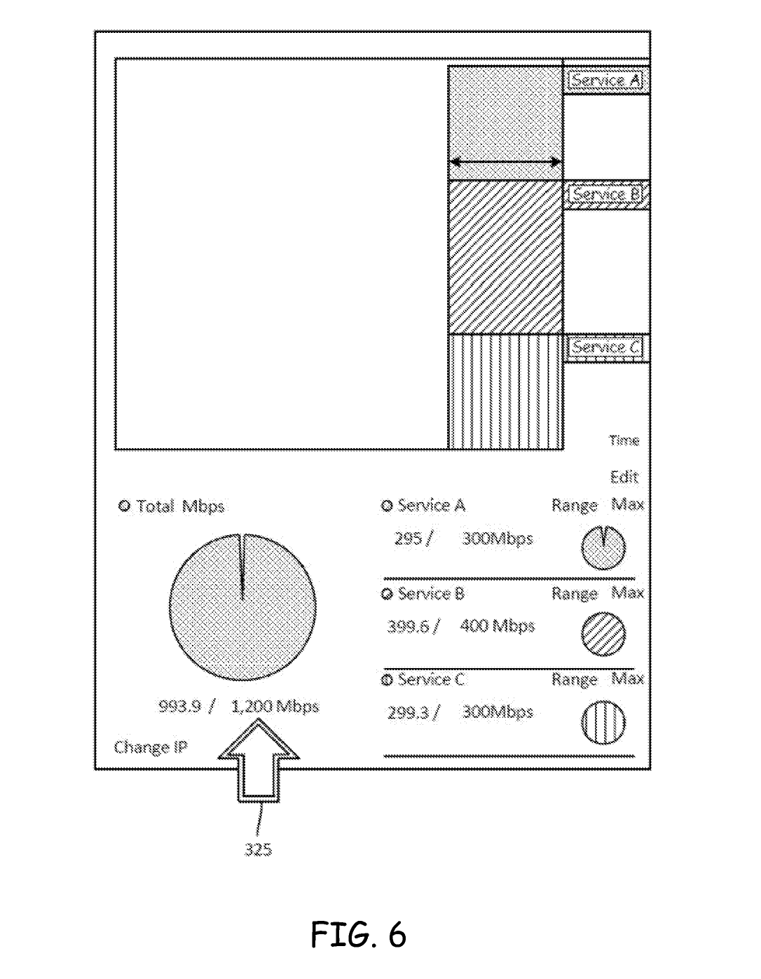

Using this method, the application allows the total bandwidth 325 purchased by end user to be changed. Clicking on total bandwidth number 325, in this example 1000 Mbps, offers a popup dialog box 400 (shown in FIG. 5) that allows the user to change the Total CIR. The application then displays the new value of 1200 Mbps for the total bandwidth number as shown in FIG. 6.

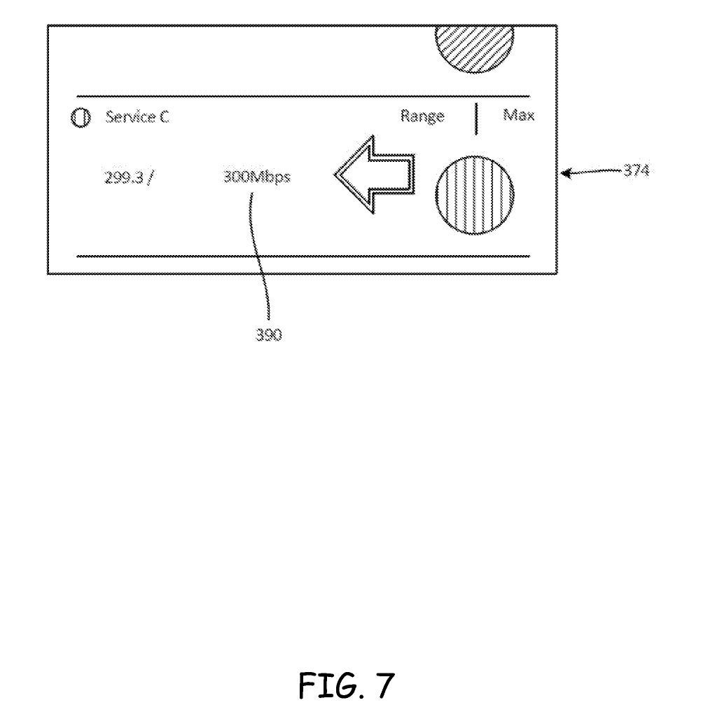

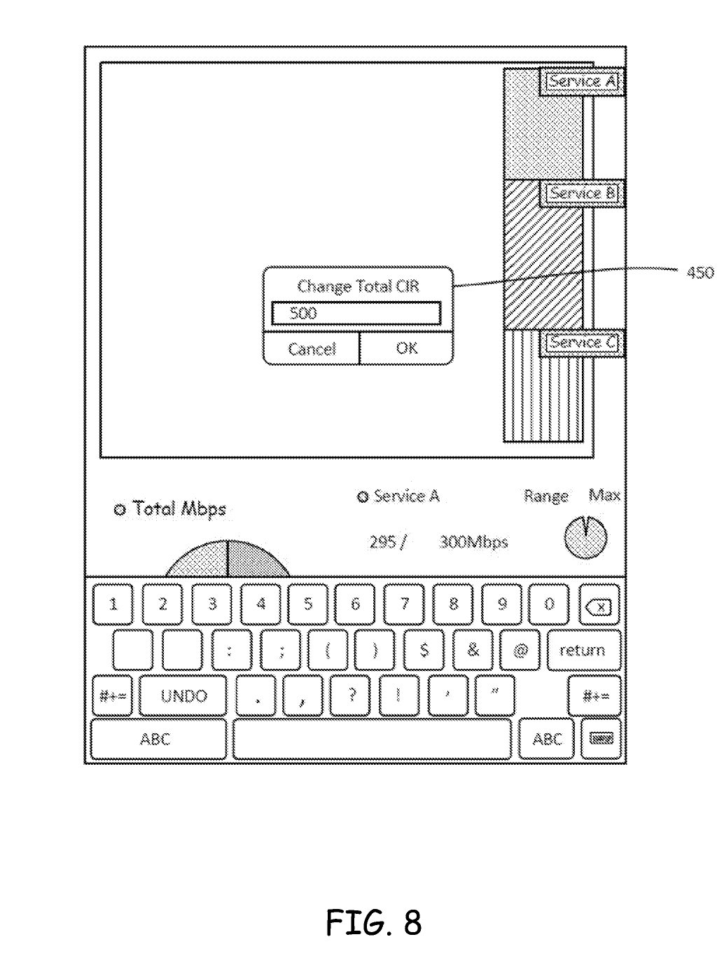

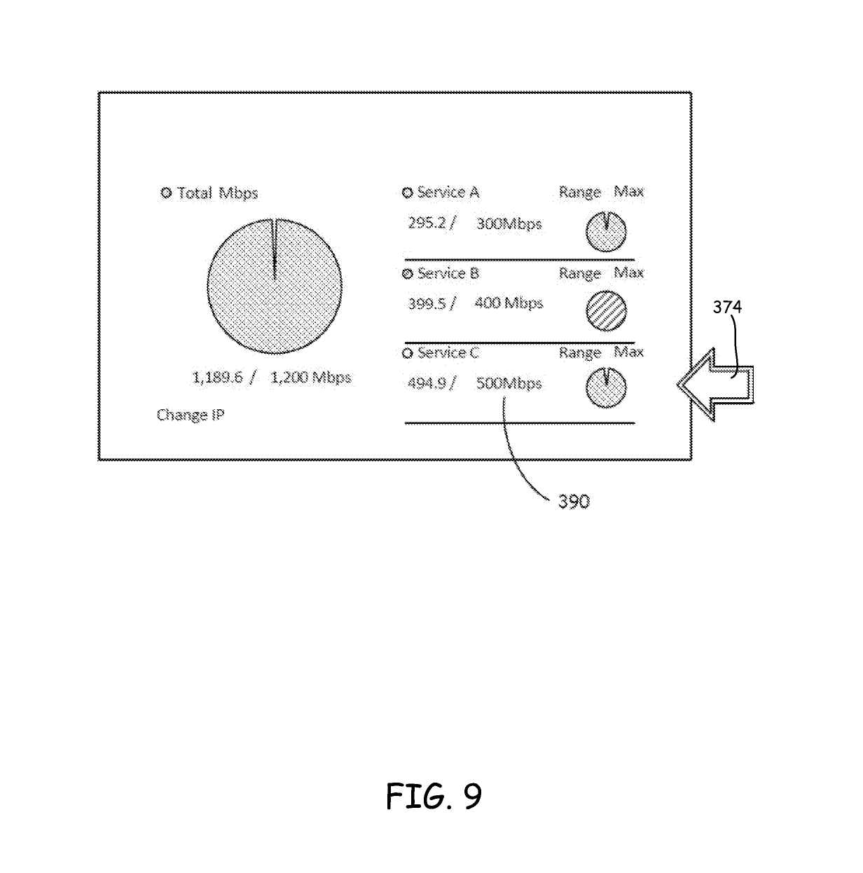

Similarly, as shown in FIG. 7, clicking on a bandwidth number 390 for one of the individual services allows the user to change the bandwidth for that service. A popup dialog box 450, as shown in FIG. 8, is generated that allows the user to enter a new maximum bandwidth for the individual service. In this example Service C is changed from 300 Mbps to 500 Mbps. FIG. 9 shows the new maximum for Service C. With the increased CIR, the incoming traffic is now less than the OR and the application now shows it as green.

Method 2: Dynamic Adjustment of Bandwidth by Changing Priorities of the Services

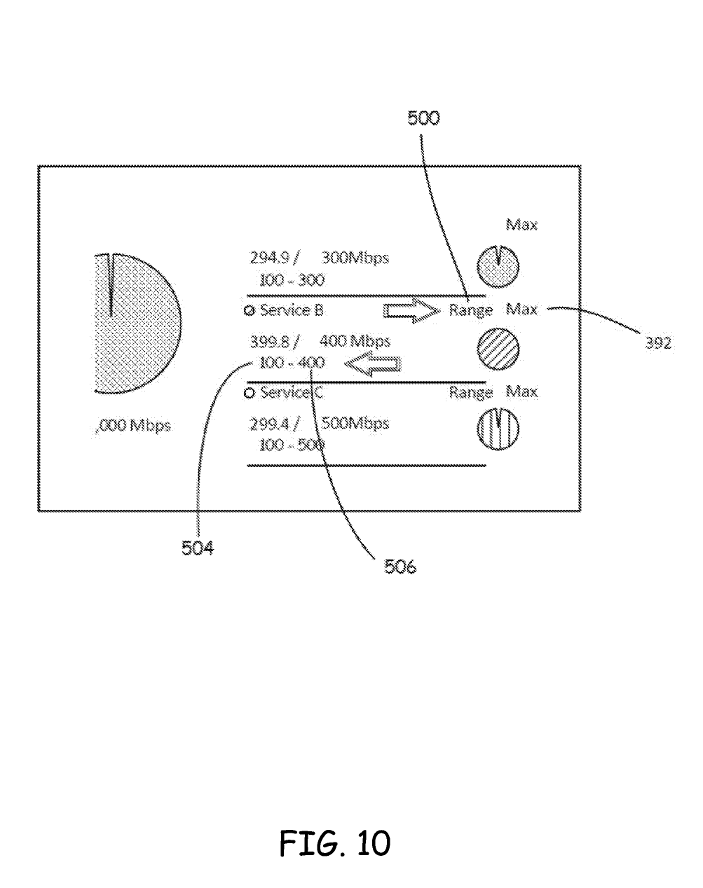

The application maintains the priority of the services, with the service illustrated at the top having the highest priority (service A in the above example). As shown in FIG. 10, clicking on “Range” 500 of input 392 will display the minimum 504 and maximum 506 allowed ranges for each service, allowing the end user to set the minimum and maximum values of the bandwidth that they want the service to have. If the maximum of the range is higher than the maximum allowed bandwidth, no adjustments will be made until the service priority is changed.

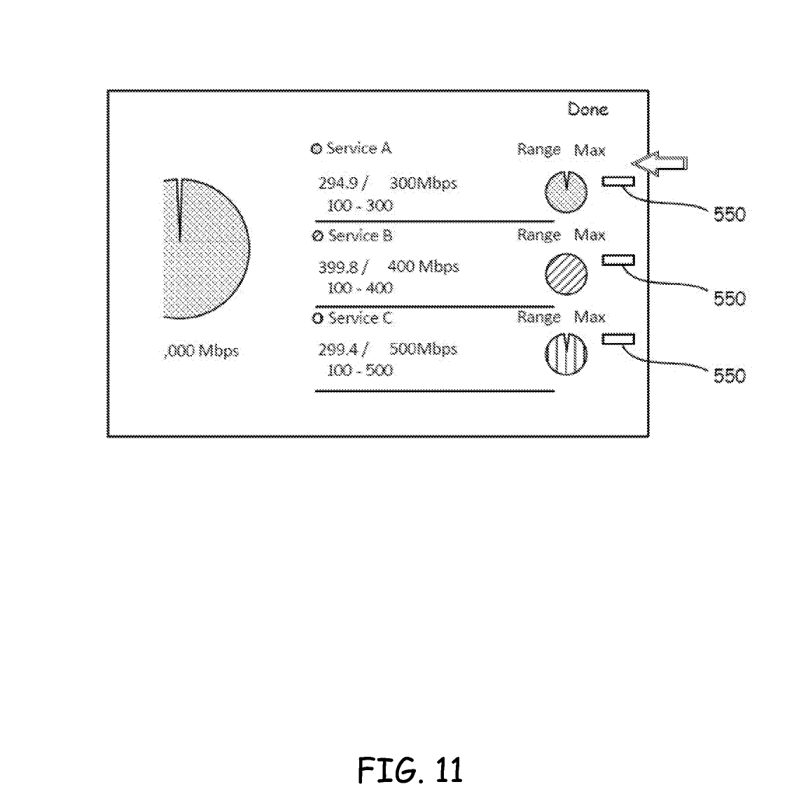

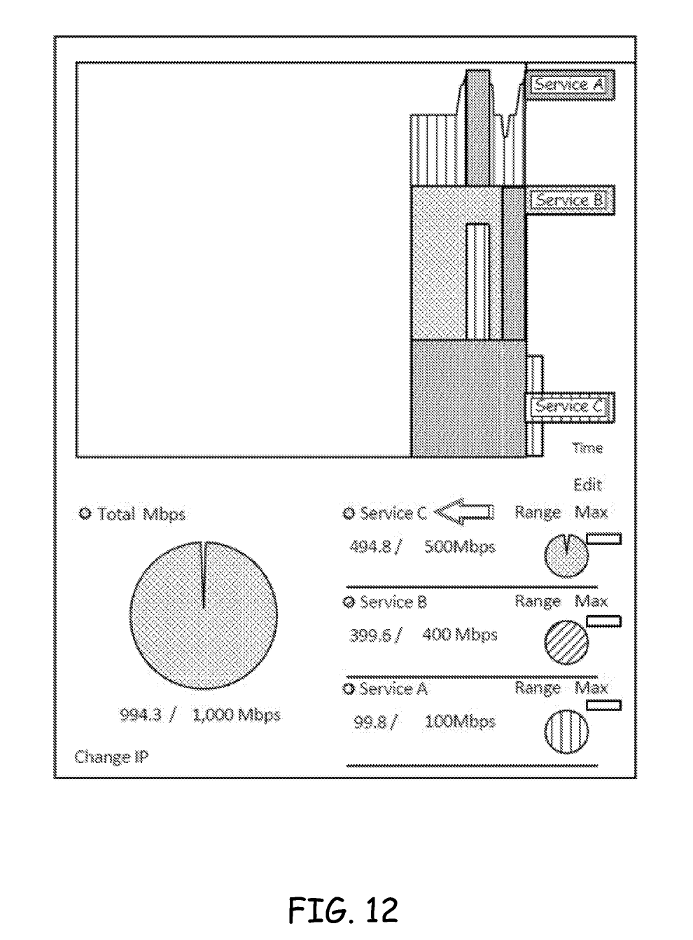

To adjust the service priorities, the end user can click on the Edit button 394 (shown in FIG. 4). This displays grabbers 550 as shown in FIG. 11 that the end user can use to drag the service up or down, thereby changing the priority. If Service C now has a higher priority, it will take away bandwidth from Service A or Service B to insure that Service C has all the bandwidth needed and is green. For example, as shown in FIG. 12, with Service C moved to the top priority and having all of the bandwidth needed, it would be shown in green in an example embodiment.

In dynamically adjusting bandwidth by changing service priorities, the three values that the application uses when making automatic adjustments to the bandwidth are:

Minimum of the range,

Minimum of the range, and

Priority (determined by position—highest priority service is on top).

All services get at least the minimum bandwidth, based on the minimum specified in the range. The highest priority service gets as much bandwidth is needed, depending on the total available bandwidth and up to the maximum of its range. The lower priority services will always get at least the minimum bandwidth in its range.

For example, assume the total available bandwidth is 1200 and the service ranges are as follows:

Service A range is 100-300,

Service B range is 100-400, and

Service C range is 200-500.

If the priority is in the order A (highest), then B and then C, Service A will receive 300 Mbps, Service C will receive its minimum of 100 Mbps and then Service B will receive at least 100 Mbps and up to 400 Mbps as needed, but Service C will never receive less than its specified minimum of 100 Mbps.

The disclosed embodiments herein include a mobile computing device application which configures a mobile computing device to provide a simple, intuitive user interface, and provide the ability to change the bandwidth of services dynamically without requiring the service to be taken down. The end user has complete control over the bandwidth and multiple was to modify it dynamically.

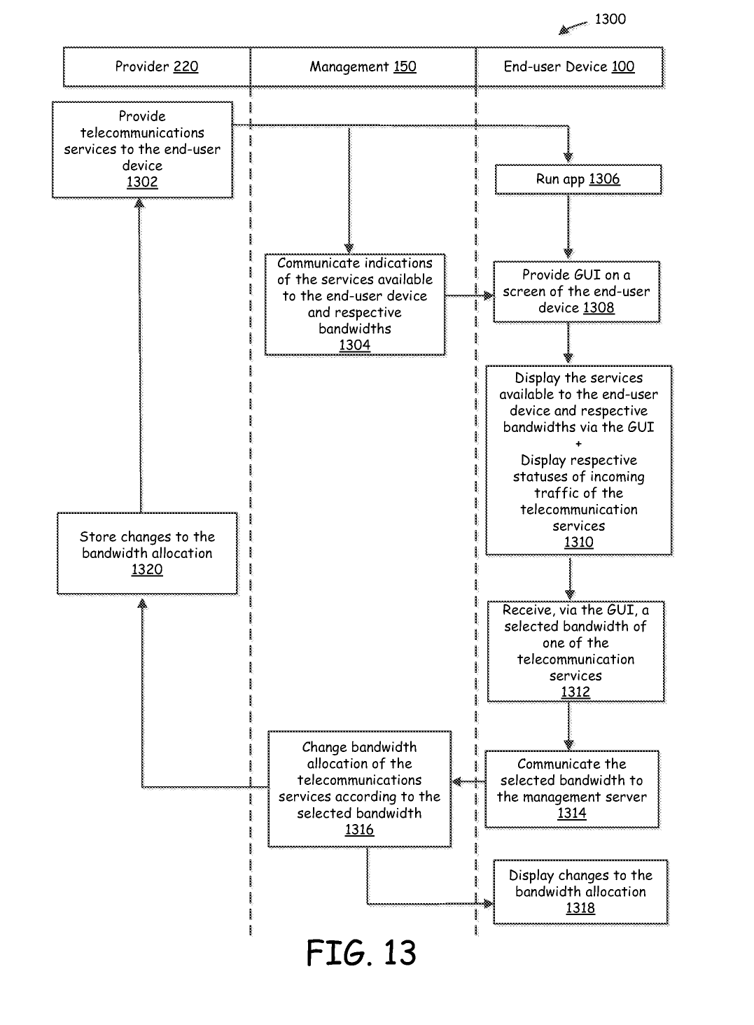

FIG. 13 is a flow chart illustrating an example embodiment of operations 1300 of the system of FIG. 2. At 1302 of the operations, the service provider networks or devices 220 provide telecommunications services to the end-user device 100. The services provided can be changed, such as changes can occur to the bandwidth allocation of the services provided to the end-user device 100. At 1304, the management system computing device 150 can communicate indications of the services available to the end-user device 100 and respective bandwidths of the services. The indications are communicated to the device 100. Meanwhile, at 1306, the end-user device can run the end-user application 200. According to the running of the application 200 and the communications of operation 1304, the application can provide GUI 202 on screen device 116 of the end-user device 100 at 1308. The GUI can display the services available to the end-user device and respective bandwidths at 1310. Also, at 1310, the GUI 202 can display respective statuses of incoming traffic of the telecommunications services. At 1312, the application 200, through the GUI 202, can receive a selected bandwidth of one of the telecommunications services. At 1314, the selected bandwidth can be communicated to the device 150 by the device 100. At 1316, the device 150 can change the bandwidth allocation of the telecommunications services according to the selected bandwidth. Indications of these changes can be communicated back to the device 100, so that the indications of change to the allocation can be displayed at 1318. At 1320, the changes to the bandwidth allocation can be stored by the service provider networks or devices 220. From the storage of the allocation, the services provided to the device 100 at 1302 can be changed accordingly.

Although the present invention has been described with reference to preferred embodiments, workers skilled in the art will recognize that changes may be made in form and detail without departing from the spirit and scope of the invention.

What is claimed is:

1. A method for end-user management of bandwidth of telecommunications services, comprising:
providing, by an end-user application running on an end-user device, a graphical user interface (GUI) on a screen of the end-user device;
receiving, via an input field of the GUI, an input indicative of a selected bandwidth of one of the telecommunications services;
communicating the selected bandwidth to a management server, wherein the management server is configured to change bandwidth allocation of the telecommunications services according to the selected bandwidth; and
receiving, by the end-user device, the one of the telecommunications services corresponding to the selected bandwidth according to the changed bandwidth allocation.

2. The method of claim 1, further comprising:
displaying, in the GUI, services of the telecommunications services available to the end-user device; and
displaying respective bandwidths of the services available to the end-user device.

3. The method of claim 2, further comprising displaying, in a first portion of the GUI, a bar of a bar graph that is indicative of one of the respective bandwidths,
wherein the vertical height of the bar is representative of the size of the bandwidth, and
wherein the horizontal width of the bar is representative of the amount of the bandwidth that is being utilized.

4. The method of claim 3, further comprising:
displaying, in a second portion of the GUI, a pie chart that is indicative of the size of the bandwidth; and
displaying a wedge in the pie chart that is representative of the amount of the bandwidth that is being utilized.

5. The method of claim 1, further comprising displaying, in the GUI, a respective status of incoming traffic of one of the telecommunications services, which includes whether the incoming traffic is passed through or whether some traffic is dropped.

6. The method of claim 5, further comprising:
comparing, by the end-user application, the incoming traffic with an allocated bandwidth and an excess information rate of the telecommunications service; and
determining a visual indication of the respective status of the incoming traffic of the telecommunications service based on the comparison.

7. The method of claim 6, further comprising:
displaying, in the GUI, the service as passed through, if the incoming traffic is less than the allocated bandwidth;
displaying, in the GUI, the service as passed through on a best-effort delivery basis, if the incoming traffic is greater than the allocated bandwidth, but less than a summation of the allocated bandwidth and the excess information rate; and
displaying, in the GUI, the service as some traffic is dropped, if the incoming traffic is greater than the summation.

8. A system for end-user management of bandwidth of telecommunications services, comprising:
an end-user application configured to:
run on an end-user device;
communicate with a management server that is configured to control bandwidth allocation of telecommunications services provided to the end-user device; and
communicate a selected bandwidth to the management server to change the bandwidth allocation of the telecommunications services; and
a graphical user interface (GUI) provided by the application, configured to:
display on a screen of the end-user device; and
provide an input field configured to receive input indicative of the selected bandwidth.

9. The system of claim 8, wherein the GUI is configured to:
display services of the telecommunications services that are available to the end-user device; and
display respective available bandwidths of the services that are available to the end-user device.

10. The system of claim 9, wherein each of the displayed available bandwidths includes a bar of a bar graph,
wherein the vertical height of the bar is representative of the size of the available bandwidth, and
wherein the horizontal width of the bar is representative of the amount of the available bandwidth that is being utilized.

11. The system of claim 9, wherein each of the displayed available bandwidths includes a pie chart, and wherein a wedge of the pie chart is representative of the amount of the available bandwidth that is being utilized.

12. The system of claim 8, wherein the GUI is further configured to display a respective status of incoming traffic of one of the telecommunications services, which includes whether the incoming traffic is passed through or whether some traffic is dropped.

13. The system of claim 12,
wherein the displayed status of the incoming traffic is based on a comparison of the incoming traffic with an allocated bandwidth and an excess information rate of the corresponding service,
wherein if the incoming traffic is less than the allocated bandwidth, the service is shown as passed through,
wherein if the incoming traffic is greater than the allocated bandwidth, but less than the summation of the allocated bandwidth and the excess information rate, the service is shown as passed on a best-effort delivery basis, and
wherein if the incoming traffic is greater than the summation, the service is shown as some traffic is dropped.

14. The system of claim 8, wherein the GUI is further configured to display changes to the bandwidth allocation of the telecommunications services in real time.

15. The system of claim 8, wherein the end-user application is configured to communicate the selected bandwidth to the management server through an application program interface (API).

16. A system for end-user management of bandwidth of telecommunications services, comprising:
communication circuitry of a management server, configured to:
communicate with an end-user application running on an end-user device, wherein the end-user application includes a graphical user interface (GUI) configured to display on a screen of the end-user device; and
receive input indicative of a selected bandwidth of one of the telecommunications services via an input field of the GUI, wherein the one telecommunications service is provided to the end-user device; and
control circuitry of the management server, configured to:
control bandwidth allocation of the telecommunications services to the end-user device; and
change the bandwidth allocation according to the selected bandwidth.

17. The system of claim 16,
wherein the selected bandwidth is selected from a list of available bandwidths of the telecommunications services displayed on the GUI,
wherein each of the displayed bandwidths includes a bar of a bar graph,
wherein the vertical height of the bar is representative of the size of the available bandwidth, and
wherein the horizontal width of the bar is representative of the amount of the available bandwidth that is being utilized.

18. The system of claim 16, wherein the control circuitry is configured to change the bandwidth allocation of the telecommunications services without taking down the telecommunications services.

19. The system of claim 16, wherein the control circuitry is configured to control the bandwidth allocation by configuring network devices of the telecommunications services.

20. They system of claim 19, wherein the network devices include flash memory configured to store changes to the bandwidth allocation of the telecommunications services.
